(19) United States
(12) Patent Application Publication
(10) Pub. No.: US 2006/0118668 A1
(43) Pub. Date: Jun. 8, 2006

(54) Vegetable cutting device

(76) Inventor: Eiji Matsumoto, Saitama-shi (JP)

Correspondence Address: BROWDY AND NEIMARK, P.L.L.C.;624 NINTH STREET, NW, SUITE 300, WASHINGTON, DC, 20001-5303, US

(21) Appl. No.: 11/002,119

(22) Filed: Dec. 3, 2004

(51) Int. Cl. B02C 17/02

(52) U.S. Cl. 241/74

(57) ABSTRACT

There is provided a vegetable cutting device that is capable of grating and other cutting processings, requires no manual operation after supplying vegetables into the device, and can automatically and efficiently grate or cut vegetables without wasting materials. The device includes: a rotor 14 that radially guides a supplied vegetable by centrifugal force; a toothed cutter cylinder 7 that has toothed cutter blades 31 and 32 and passing-through holes 30 for a processed vegetable in an inner peripheral surface thereof and surrounds the rotor 14 with a slight gap; and a collecting portion 5 having a cover that surrounds the toothed cutter cylinder 7 and is arranged outside the toothed cutter cylinder 7 with a processed vegetable discharge space for receiving the vegetable discharged from the passing-through holes 30.

### BACKGROUND OF THE INVENTION

1. Field of the Invention

The present invention relates to a vegetable cutting device, and more particularly to a vegetable cutting device for automatically grating or cutting vegetables such as radishes in producing grated radish, dried radish strips, stir-fried burdock and carrot strips or the like in volume in food factories, supermarkets, or large restaurants. The word “cutting” herein covers various processings using tools such as a knife or a grater in preparing vegetables such as cutting, slicing, or grating.

2. Description of the Related Art

Food factories, department stores, supermarket, catering services, or restaurants that need grated radish, dried radish strips, stir-fried burdock and carrot strips, or cut vegetable materials for them in volume often rely on machines rather than a manual operation for grating, cutting, or slicing the vegetables in terms of efficiency and costs.

For example, a known vegetable grater is described in Japanese Patent Laid-Open No. 10-85140. This grater is such that vegetables are supplied onto a shallow bowl-shaped grating board that horizontally rotates in a frame, and the vegetables are manually pressed onto the grating board from above using a pressing member.

For this vegetable grater, the vegetables must be manually continuously pressed using the pressing member during processing, and also vegetables cut into small pieces tend to fall in a gap between grater parts (grating pieces) of the grating board, which tends to cause waste.

As described above, the conventional vegetable grater requires a manual operation during processing, thereby increasing operation costs and causing waste of materials.

### SUMMARY OF THE INVENTION

In view of the above described problems, the invention has an object to provide a vegetable cutting device that is capable of grating and other cutting processings, requires no manual operation after supplying vegetables into the device, and can automatically and efficiently grate or cut vegetables without wasting materials.

The invention provides a vegetable cutting device including: a rotor that radially guides a supplied vegetable by centrifugal force; a toothed cutter cylinder that has toothed cutter blades and passing-through holes for a processed vegetable in an inner peripheral surface thereof and surrounds the rotor with a slight gap; and a collecting portion having a cover that surrounds the toothed cutter cylinder and is arranged outside the toothed cutter cylinder with a processed vegetable discharge space for receiving the vegetable discharged from the passing-through holes.

Preferably, the collecting portion includes a hood having an inclined bottom surface that forms a bottom surface of the discharge space, and the rotor includes partition plates radially mounted to a rotation axis or partition plates assembled into a lattice around a rotation axis.

Other objects or features of the invention will become more apparent from the accompanying drawings and the following description.

### BRIEF DESCRIPTION OF THE DRAWINGS

FIG. 1 is a front view of a vegetable cutting device according to the invention;

FIG. 2 is a plan view of the vegetable cutting device according to the invention;

FIG. 3 is a perspective view of essential portions of the vegetable cutting device according to the invention;

FIG. 4 is a perspective view of configuration examples of a toothed cutter cylinder and a rotor in the vegetable cutting device according to the invention;

FIG. 5 is a perspective view of essential portions of the toothed cutter cylinder in FIGS. 3 and 4;

FIG. 6 is a perspective view of another configuration example (for slicing) of a toothed cutter cylinder;

FIG. 7 is a perspective view of essential portions of the toothed cutter cylinder in FIG. 6;

FIG. 8 is a perspective view of another configuration example of a rotor;

FIG. 9 is a perspective view of essential portions of the toothed cutter cylinder in FIG. 8;

FIG. 10 is a vertical sectional view of another embodiment of a vegetable cutting device according to the invention;

FIG. 11 is an exploded perspective view of the vegetable cutting device in FIG. 10;

FIG. 12 is a developed view of a toothed cutter cylinder in the vegetable cutting device in FIG. 10; and

FIG. 13 is a perspective view of another configuration example of a collecting portion in the vegetable cutting device in FIG. 10.

### DETAILED DESCRIPTION OF THE PREFERRED EMBODIMENTS

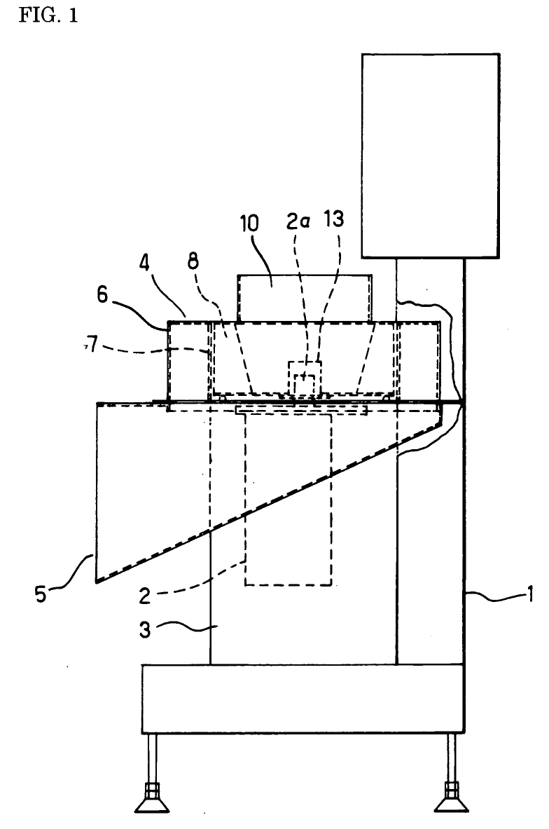

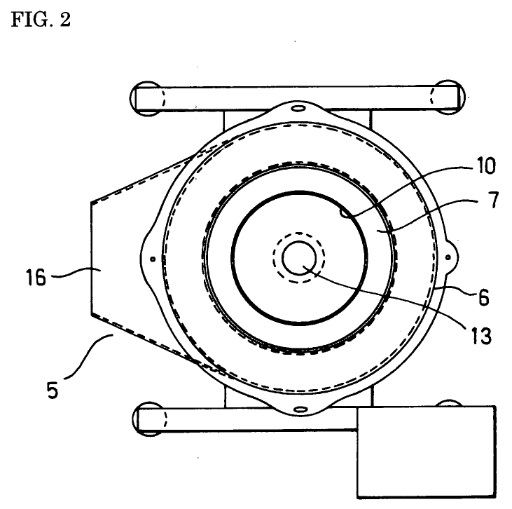

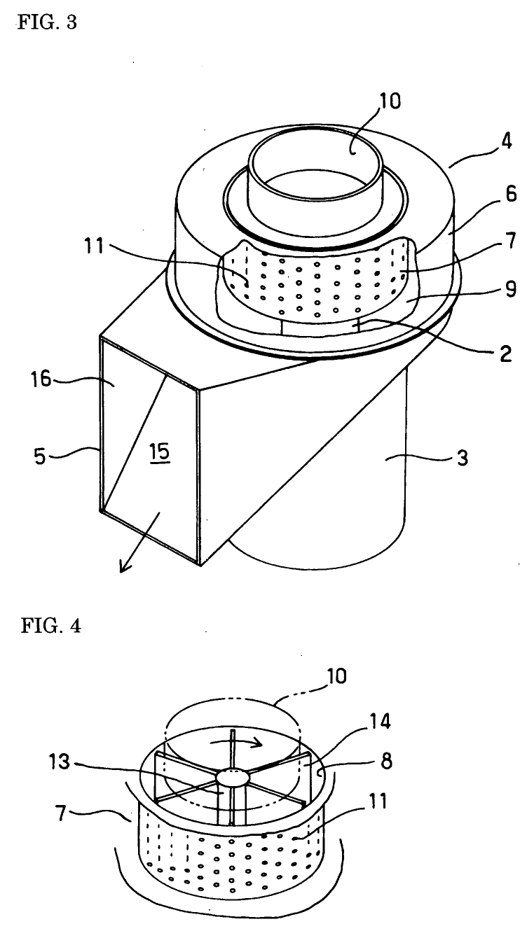

Embodiments of the invention will be described with reference to the accompanying drawings. FIG. 1 is a front view of a device according to an embodiment of the invention, FIG. 2 is a plan view thereof, and FIG. 3 is a perspective view of essential portions thereof. In the drawings, reference numeral 1 denotes a frame. A motor case 3 including a motor 2 is placed on the frame 1, and a cutting portion 4 and a collecting portion 5 are provided on the motor case 3.

The cutting portion 4 has a cylindrical shape and concentrically includes a cover 6, a toothed cutter cylinder 7, and a rotor 8 in order from outside. The toothed cutter cylinder 7 is placed on an upper surface of the motor case 3, and a sufficient space is held between the cover 6 and the toothed cutter cylinder 7 in order to ensure a processed vegetable discharge space 9 for receiving a processed vegetable discharged from the toothed cutter cylinder 7 (see FIG. 3).

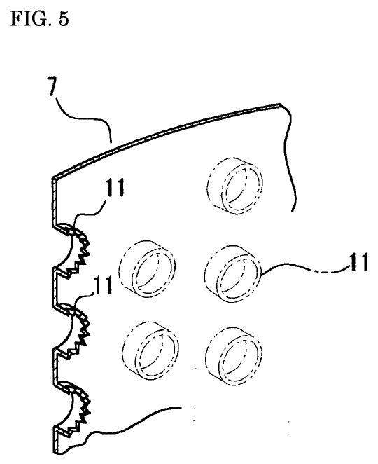

The toothed cutter cylinder 7 has various toothed cutter blades and passing-through holes for the processed vegetable in an inner peripheral surface thereof, and has a supply port 10 for vegetables on an upper surface thereof. The toothed cutter cylinder 7 in FIGS. 3 to 5 is a toothed cutter cylinder for grating radishes or the like, and the inner peripheral surface thereof is formed like a grater. To this end, for example, small holes are punched inward to provide a large number of toothed small holes 11 with rising teeth along the small holes (FIG. 5). In this case, the toothed small holes 11 serve as both toothed cutter blades and passing-through holes, and a processed vegetable such as grated radish produced by a below described operation is discharged from an inside through the toothed small holes 11 into the processed vegetable discharge space 9.

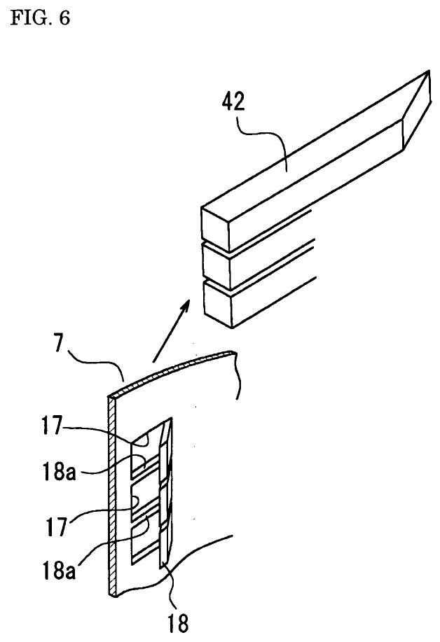

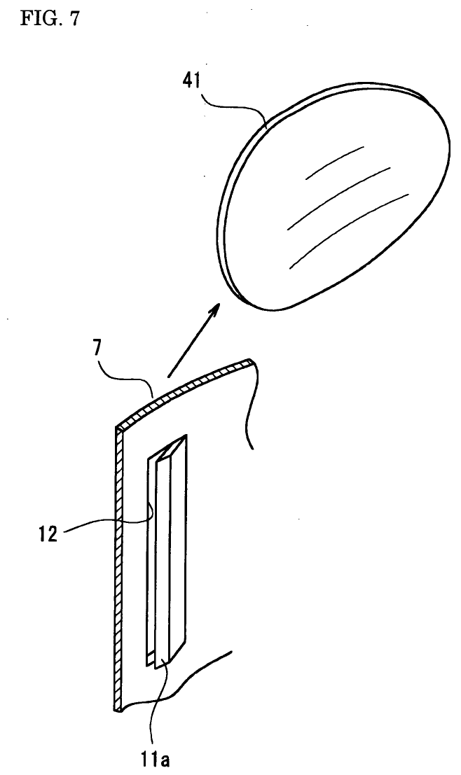

A toothed cutter cylinder 7 in FIGS. 6 and 7 is a toothed cutter cylinder 7 for slicing potatoes for producing potato tips. In this case, elongate vertical holes 12 are provided, for example, at eight places symmetrically in upper and lower rows, and a cutter blade 11a is placed along one vertical side of each of the vertical holes 12. In this case, a vegetable 41 sliced by a below described operation is discharged thorough the vertical holes 12 into the processed vegetable discharge space 9.

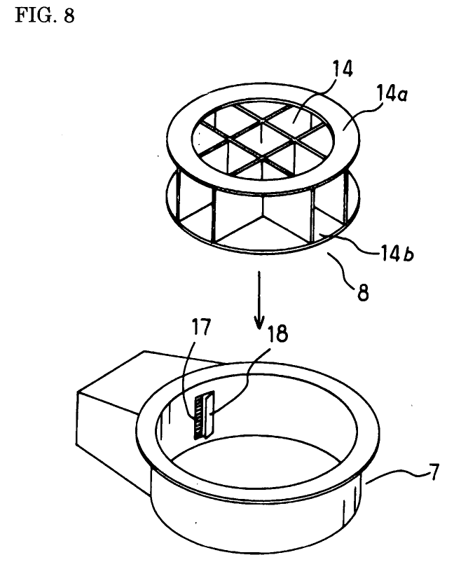

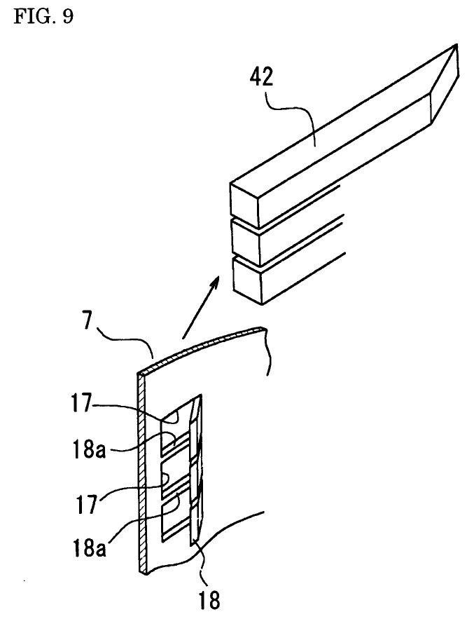

Further, in order to cut radishes, carrots, or burdocks into sticks to obtain stick vegetables 42 for producing dried radish strips or stir-fried burdock and carrot strips, rectangular passing-through holes 17 may be vertically arranged, one vertical side thereof may be extended to form a cutter blade 18, and further, a partition between the vertical passing-through holes 17 may form a cutter blade 18a (FIGS. 8 and 9).

Further toothed cutter cylinders 7 have various toothed cutter blades and passing-through holes adapted for vegetables to be cut in inner peripheral surfaces thereof, and such various toothed cutter cylinders 7 are preferably adapted to be selected according to use thereof and changeably attached to the upper surface of the motor case 3.

For changeability, for example, an uneven portion is provided in a bottom surface of the toothed cutter cylinder 7, and the uneven portion is fitted into an uneven portion corresponding thereto provided on the upper surface of the motor case 3 to hold the toothed cutter cylinder 7 on the motor case 3. In this way, the cover 6 is removed to easily attach and detach, and also position the toothed cutter cylinder 7.

A rotor 8 is rotatably driven by the motor 2 to apply centrifugal force to the vegetable supplied from the supply port 10 into the toothed cutter cylinder 7 and rub the vegetable against the inner surface of the toothed cutter cylinder 7 at high speed, and has in a center thereof a rotation axis 13 connected to an output shaft 2a of the motor 2.

The rotor 8 in FIG. 4 includes six partition plates 14 radially extending from the rotation axis 13 to immediately near the inner peripheral surface of the toothed cutter cylinder 7. The vegetable supplied from the supply port 10 into a sector formed between each two partition plates 14 is pressed by the partition plates 14 with the rotation of the rotor 8, pressed against the inner peripheral surface of the toothed cutter cylinder 7 by the centrifugal force, and moved along the inner peripheral surface as it is at high speed.

The vegetable is continuously rubbed against the toothed cutter blade while the movement, and for the toothed cutter cylinder 7 for grating in FIGS. 3 to 5, the grated radish produced by the toothed small holes 11 is discharged through the toothed small holes 11 into the processed vegetable discharge space 9 in succession.

For the toothed cutter cylinder 7 in FIGS. 6 and 7, sliced vegetables 41 are produced by the cutter blade 11a, and for the example in FIGS. 8 and 9, stick vegetables 42 are produced by the cutter blades 18 and 18a, and the vegetables 41 and 42 are discharged through the vertical holes 12 and the passing-through holes 17, respectively, into the processed vegetable discharge space 9. In either case, the vegetable is continuously rubbed against the toothed cutter blade by centrifugal force regardless of a size of the vegetable (strictly, until the size of the vegetable becomes smaller than a gap between the toothed cutter cylinder 7 and the partition plate 14 of the rotor 8), thereby causing no waste.

The rotor 8 in FIG. 8 includes partition plates 14 assembled into a lattice so as to surround a rotation axis 13, with a doughnut-shaped upper plate 14a secured to an upper surface thereof and a circular lower plate 14b secured to a lower surface thereof. Each partition plate 14 works on the vegetable similarly as the above described case. This rotor 8 is, for example, used for cutting carrots and burdocks into sticks for stir-fried burdock and carrot strips. In this case, a toothed cutter cylinder 7 has passing-through holes 17 and cutter blades 18 and 18a as described above.

The collecting portion 5 includes a sliding surface 15 inclined downward that forms a bottom surface of the processed vegetable discharge space 9 placed so as to surround the toothed cutter cylinder 7, and a hood 16 that covers the sliding surface 15 (see FIG. 3). Grated radish or other processed vegetable discharged into the processed vegetable discharge space 9 falls onto the sliding surface 15 and slides, and is collected into a container.

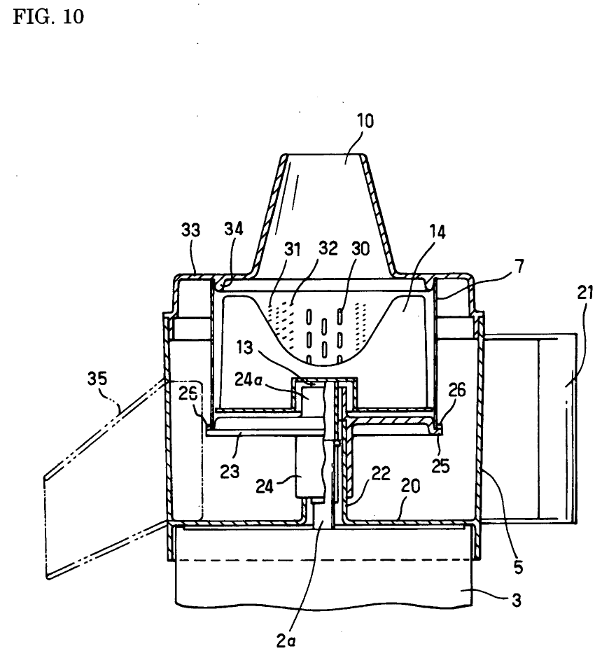

An embodiment in FIGS. 10 to 13 shows a more compact configuration of a vegetable cutting device according to the invention. A cylindrical collecting portion 5 having a handle 21 is placed on a motor case 3. A rising cylinder 22 is formed in a center of a bottom surface 20 of the collecting portion 5, and an output shaft 2a extending from the motor case 3 is inserted into the rising cylinder 22.

A receiving table 23 on which a toothed cutter cylinder 7 is placed is detachably mounted to the rising cylinder 22. The receiving table 23 has a shaft cylinder 24 covering the rising cylinder 22 on a back surface thereof. An outer side surface of the rising cylinder 22 and an inner side surface of the shaft cylinder 24 have uneven structures corresponding to each other, or both the cylinders are splined to each other so that they are axially movable but not rotatable relative to each other. Alternatively, both the cylinders may be threaded to be in threading engagement with each other.

The receiving table 23 has a flange 25 on which the toothed cutter cylinder 7 is placed, and locking protrusions 26 are placed on an upper surface of the flange 25 at predetermined intervals. Locking recesses 27 of the toothed cutter cylinder 7 described later engage the locking protrusions 26.

A shaft cylinder 24a through which a rotation axis 13 protruding from a bottom surface of a rotor 8 is inserted with play is placed in a center of an upper surface of the receiving table 23. On a rotating plate of the rotor 8 having a slightly smaller diameter than an inner diameter of the toothed cutter cylinder 7, a partition plate 14 having a length substantially corresponding to the diameter of the rotating plate is placed with a center of the partition plate 14 being secured to the rotation axis 13.

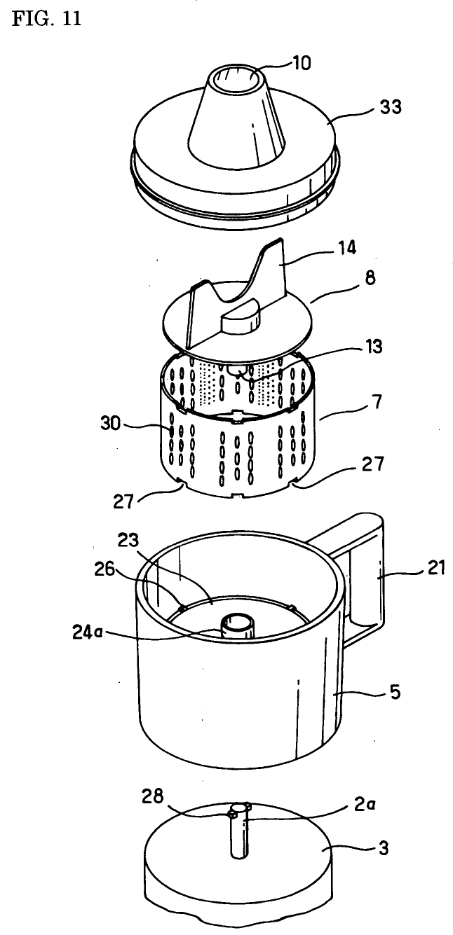

The rotation axis 13 is inserted into the shaft cylinder 24 from above so as to be engageable with the output shaft 2a of a motor, thereby allowing transmission of rotating power. Any engagement means may be used, and for example, a protrusion 28 (FIG. 11) on the output shaft 2a may be locked into a vertical groove provided in the rotation axis 13.

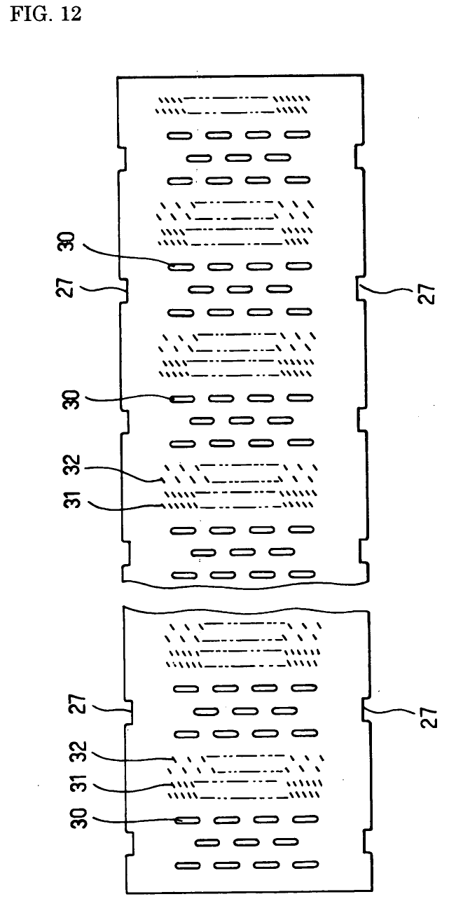

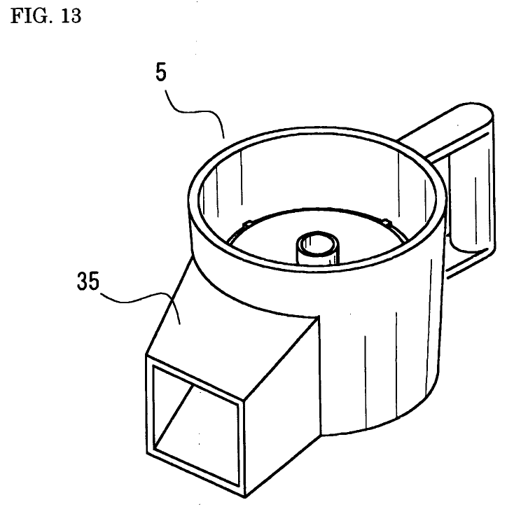

The toothed cutter cylinder 7 herein shown can be used upside down, and includes the locking recesses 27 in an upper side and a lower side, passing-through portions that have a plurality of passing-through holes 30 arranged in parallel and are placed at appropriate intervals, and two types of toothed cutter blade rows 31 and 32 provided between the passing-through portions, as shown in a developed view of the toothed cutter cylinder 7 in FIG. 12. For example, the toothed cutter blade row 31 has a fine blade, and the toothed cutter blade row 32 has a large and rough blade.

For the toothed cutter cylinder 7 including the toothed cutter blade rows 31 and 32, a method for first processing a vegetable by the fine toothed cutter blade row 31 and then processing the vegetable by the rough toothed cutter blade row 32, and a method for first processing the vegetable by the rough toothed cutter blade row 32 and then processing the vegetable by the fine toothed cutter blade row 31 can be selected by turning the toothed cutter cylinder 7 upside down. The property of the processed vegetable differs depending on which method is used.

A lid 33 having a supply port 10 is placed over the collecting portion 5. An annular protrusion 34 is formed on a back surface of the lid 33, and when the lid 33 is placed over the collecting portion 5, the annular protrusion 34 fits into an upper portion of the toothed cutter cylinder 7 to support the toothed cutter cylinder 7.

In this case, the processed vegetable discharged from the toothed cutter cylinder 7 and stored in the collecting portion 5 is taken out of the collecting portion 5 after the collecting portion 5 is removed from the motor case 3, and the lid 33 is removed to draw the toothed cutter cylinder 7 together with the receiving table 23. The processed vegetable can be taken out while holding the handle 21 of the collecting portion 5.

In this embodiment, the processed vegetable can be collected via a collecting chute 35 provided obliquely downward with part of a side surface of the collecting portion 5 being opened (see a virtual line in FIG. 10 and FIG. 13)

In any of the above described cases, the toothed cutter cylinder 7 and the rotor 8 are selectively combined according to a vegetable to be cut, thereby accommodating various types of cutting.

As described above, the vegetable cutting device according to the invention has an advantage that the device has a compact and simple configuration, is capable of producing grated radish, dried radish strips, burdock and carrot strips for stir-fry or the like in volume efficiently without any manual operation and without wasting materials, and can be used for various types of cutting by changing the toothed cutter cylinder.

What is claimed is:

1. A vegetable cutting device comprising:
a rotor that radially guides a supplied vegetable by centrifugal force;
a toothed cutter cylinder that has toothed cutter blades and passing-through holes for a processed vegetable in an inner peripheral surface thereof and surrounds said rotor with a slight gap; and
a collecting portion having a cover that surrounds said toothed cutter cylinder and is arranged outside said toothed cutter cylinder with a processed vegetable discharge space for receiving the vegetable discharged from said passing-through holes.

2. The vegetable cutting device according to claim 1, wherein said collecting portion includes a hood having a sliding surface that forms an inclined bottom surface of said discharge space.

3. The vegetable cutting device according to claim 1, wherein said rotor includes partition plates radially mounted to a rotation axis.

4. The vegetable cutting device according to claim 1, wherein said rotor includes partition plates assembled into a lattice around a rotation axis.

5. The vegetable cutting device according to claim 1, wherein said passing-through holes are a large number of small holes, and said toothed cutter blades are formed like a grater with rising peripheral edges of the small holes.

6. The vegetable cutting device according to claim 1, wherein a rising cylinder is provided in a center of a bottom surface of said collecting portion, a shaft cylinder of a table is fitted and secured to said rising cylinder to place the table, and the toothed cutter cylinder is placed on said table.

7. The vegetable cutting device according to claim 6, wherein locking protrusions that engage locking recesses provided in an upper side and a lower side of the toothed cutter cylinder are provided at several places in a periphery of said table.

8. The vegetable cutting device according to claim 6, wherein a plurality of toothed cutter blade rows of different types are placed between passing-through hole rows of said toothed cutter cylinder.

9. The vegetable cutting device according to claim 6, wherein said collecting portion includes a handle.
